(19) United States
(12) Patent Application Publication
(10) Pub. No.: US 2002/0087683 A1
(43) Pub. Date: Jul. 4, 2002

(54) WAP network printing

(75) Inventor: Gyorgy Szondy, Budapest (HU)

Correspondence Address: Michael C. Stuart, Esq., Cohen, Pontani, Lieberman & Pavane, Suite 1210, 551 Fifth Avenue, New York, NY, 10176, US

(73) Assignee: Nokia Corporation

(21) Appl. No.: 09/750,817

(22) Filed: Dec. 28, 2000

(51) Int. Cl. G06F 15/173; G06F 17/30; G06F 7/00

(52) U.S. Cl. 709/225; 707/10

(57) ABSTRACT

A system including a data network and a Wireless Application Protocol (WAP) gateway for providing network content to wireless terminals allows a user of a wireless terminal to designate another network node as a destination for network content, and to selectively route network content to the designated network node. The designated network node may have capabilities not found in the wireless terminal, such as hard-copy printing or permanent retention.

### BACKGROUND OF THE INVENTION

1. Field of the Invention

The present invention relates to WAP-enabled wireless terminals, and particularly to printing of Internet content data selected from a wireless terminal.

2. Description of the Related Art

Wireless communication devices are becoming more common, and are becoming adapted for data communication as well as voice communication. The “Internet-ready” wireless terminal is becoming commonplace, and may be used to access and display textually a portion of the information users are accustomed to accessing on their PCs. (The smaller display screen and general lack of graphics capability preclude the wireless terminal from displaying everything that could be displayed on a PC.) Wireless Application Protocol (WAP) has been specified for Internet-related data applications by leading telecom and software vendors. A goal of the WAP specification has been to create an open standard that will enable creation of value-added services that can be used with wireless terminals and with server products from various vendors.

The WAP specification defines a set of content formats that are used in creation of the wireless services. In principle, WAP enables content conversion from existing Internet content formats to WAP-defined content formats. Also, since WAP is intended to be an open specification, in principle it ensures that content written according to its specifications will be usable on various terminal types from various manufacturers.

A user accessing information from the Internet by means of a PC often elects to print a “hard copy” of selected information. A typical wireless terminal, such as a mobile phone, typically does not have a printer associated with it, so a user accessing the Internet from a wireless terminal does not have that option. A prior-art solution is to use an infrared data connection (as sanctioned by the IrDA (Infrared Data Association) specification) between a wireless terminal with IrDA capability and a proximate IrDA-capable printer. An analogous arrangement is possible using an LPRF (low-power radio frequency) connection according to the Bluetooth specification. Both these solutions have the disadvantages of requiring the user to be proximate to a suitably equipped (with IrDA or LPRF) printer and to have a suitably equipped wireless terminal. Further, as discussed below, the information that reaches the wireless terminal is often only a subset of the information available from the Internet, due to the limited display capabilities of a wireless terminal.

There is thus a need to provide a user accessing the Internet by means of a wireless terminal with a means of printing network content without being proximate to a printer and without expanding the capabilities of the wireless terminal.

### SUMMARY OF THE INVENTION

According to the present invention, a user-supplied indication of another network node, typically one with printing capability, is stored. Further, a user-supplied request to redirect content to that other network node is stored. Network-derived content is routed to the other network node if a request to redirect is presently stored, and to the user's wireless terminal if a request to redirect is not presently stored. After redirecting content, the stored request is cleared.

In an aspect of the invention, network-derived content originates in HTML format, and is converted to WAP format; the user may request that WAP-format data be routed to the other network node, or that network-derived HTML-format data be routed to the other network node.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numerals denote similar elements:

FIG. 1 is a diagram of a network diagram including mobile terminals communicating through WAP gateways to the Internet, and in which the present invention may be practiced; and

FIG. 2 illustrates flow according to the present invention within a component of FIG. 1.

### DETAILED DESCRIPTION OF THE PRESENTLY PREFERRED EMBODIMENTS

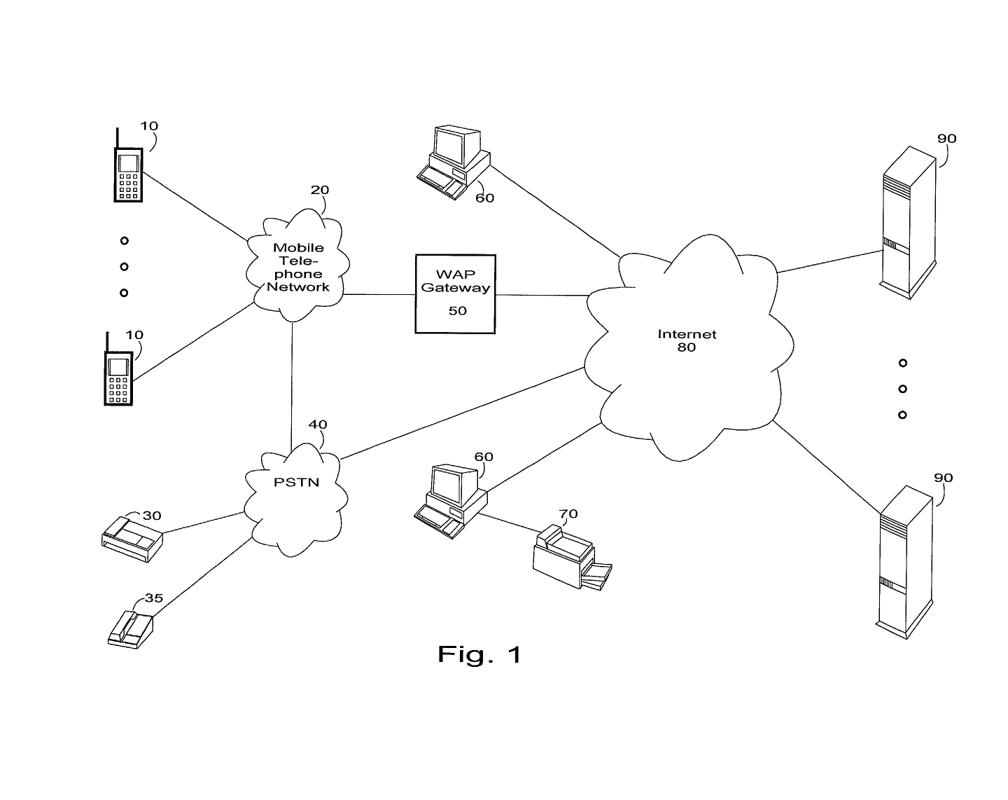

FIG. 1 is a block diagram of a network in which the present invention may be practiced. A plurality of wireless terminals 10 communicate through wireless telephone network 20, which allows wireless terminals 10 to communicate with one another, or through the public switched telephone network (PSTN) 40 to communicate with the many telephone devices connected thereto, represented by FAX machine 30 and telephone 35.

Wireless telephone network 20 also enables a wireless terminal 10 to connect to WAP gateway 50 and thus to communicate, in wireless application protocol (WAP), with the Internet 80. Such users at wireless terminals 10, as well as users at PCs 60, may request through the Internet 80 to access content from a plurality of servers 90. Servers 90 typically store content in hypertext markup language (HTML), and typically forward HTML directly to PCs 60. PCs 60 generally are capable of displaying the rich text (e.g., variegated fonts) and the graphics represented in HTML.

Wireless terminals 10, on the other hand, are typically much more limited in the repertoire of fonts they can display, and in their ability to display graphics. A more austere language than HTML, known as wireless markup language (WML), has been devised for displaying at least a subset of Internet content on wireless terminals 10. In a server 90 or in a WAP gateway 50 (it is a design choice as to which one), content destined for a wireless terminal 10 is translated from HTML to WML. The ensuing discussion is oriented toward a scheme in which conversion from HTML to WML is performed in WAP gateway 50, but it will be apparent to those in the art that the inventive principles may be applied as well to a scheme in which the conversion is performed in a server 90.

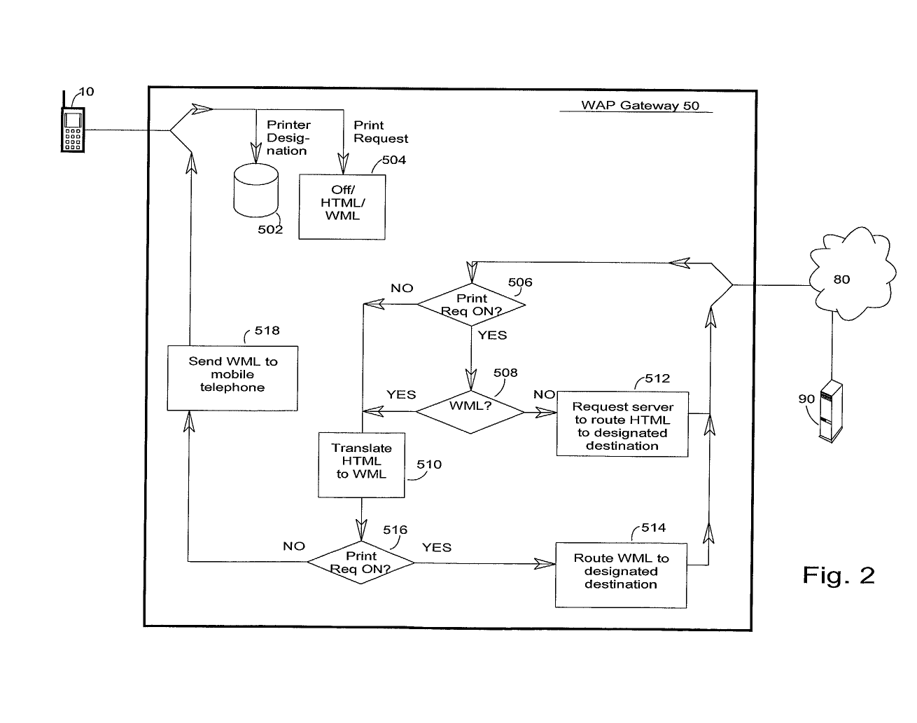

FIG. 2 depicts the inventive functions that take place within WAP gateway 50. (Prior-art functions of WAP gateway 50 are not shown in FIG. 2.) A user at a wireless terminal 10 (connected through wireless telephone network 20, not shown in FIG. 2) is in communication through WAP gateway 50 to the Internet 80 and then to a server 90, and is receiving content that originates from a server 90.

Content is viewed on wireless terminal 10 as in the prior art, but in accordance with the present invention, wireless terminal 10 designates a terminal node or device to which content may be redirected. Redirecting content is referred to generally herein as “printing” of the content, but those in the art realize that such redirection may handle content in some manner other than “printing” in the literal sense. For example, most popular word processing programs provide an option to “print to a file”, although that is a term of art and does not directly result in literal printing. The user's designation of a node for redirection is retained in data store 502. As a design choice, it may be resident in data store 502 in a non-volatile manner for retrieval each time a particular wireless terminal 10 makes connection with WAP gateway 50, or it may be resident in the wireless terminal 10 and provided to data store 502 each time the wireless terminal 10 makes connection. The user may change the node designation when desired. That there is a designation made does not of itself necessarily bring about printing of content; the user may specifically request that printing be performed.

In a preferred embodiment of the invention, the user may request printing of the content as seen on wireless terminal 10 (transmitted to wireless terminal 10 in WML), or he may request printing of the original HTML content from which the WML content is derived. In an alternative embodiment, printing may be requested only of the WML content. In the preferred embodiment, a user of wireless terminal 10 signifies by an action on wireless terminal 10 that printing is desired, and whether to print HTML or WML content. It is a design choice how this action is signaled; in the preferred embodiment it is selected from a menu portion of the display, but alternatively it may be such as a predetermined keypress or sequence of keypresses. Status indication 504 represents the storage of whether printing is requested, and if so, whether it is to be WML or HTML printing. Prior to requesting printing, status indication 504 reflects the OFF condition. After a printing request is satisfied, status indication 504 is returned to the OFF condition by logic circuitry not shown in FIG. 2.

HTML content retrieved from server 90 and transmitted through Internet 80 arrives at WAP gateway 50. If no print request has been made (as indicated by status indication 504), decision 506 invokes process 510 to translate the HTML content to WML. Process 510 is also invoked by decision 508 in the case where a print request has been made, but it is to print WML. After translation to WML, decision 516 invokes process 518 to transmit the WML content to wireless terminal 10 if a print request is not in effect.

Redirection can be requested by either of process 512 or process 514. Process 512 would be reached if decision 506 determines (according to status indication 504) that a print request is on, and if decision 508 determines that it is not a request for WML, which in the preferred embodiment leaves only an HTML print request as a possibility. In the preferred embodiment, process 512 requests server 90 to forward an entire HTML document to the destination designated in data store 502; the user at wireless terminal 10 is viewing in a WML translation and is probably currently viewing only a portion of the document because of display limitations of wireless terminal 10, but in response to his print request the entire HTML document is printed. In the alternative, the user may have requested to print the WML portion he is currently viewing, in which case decision 516 dispatches to process 514, which routes the current portion of WML to the designated node via Internet 80.

There are cases in which the WML content viewed by the user contains more information than the HTML content obtained from source, such as a WML form sent to the wireless terminal to be filled in by a user, or a WML deck that modifies itself according to client-side variables after arriving at the wireless terminal. In such cases, the user should opt to print the WML rather than the HTML content.

FIG. 1 shows many of the nodes to which the user at a wireless terminal 10 might redirect content. He might redirect to an email address for subsequent viewing on a PC 60, and for subsequent printing on a printer 70 associated with a PC 60. If a PC 60 and a printer 70 are configured so that the printer 70 has a network address, he might redirect content directly to a printer 70. If a disk drive associated with a PC 60 has a network address, he could redirect content to a file on that disk drive. He might redirect content to a facsimile machine 30 at his home. (Content would have to undergo a format translation, as is known in the art.)

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. In a data network including a gateway server for interfacing data content obtained from a content server to a node comprising a mobile terminal, apparatus for redirecting at least some of the data content to another network node, comprising:
a data store for storing a user-supplied designation of the other network node;
a sensible indicator for indicating whether the user has requested redirection of data content; and
a data path operatively connected to the data store and to the sensible indicator and adaptable to route data content to the mobile terminal or to the other network node designated in the data store according to the sensible indicator.

2. The apparatus of claim 1 wherein:
the content from the server is in HTML format; and
the data path is further adaptable to convert content to WAP format and to selectably route WAP-format content to the mobile terminal or to the other network node.

3. The apparatus of claim 2, wherein the data path is further adaptable to instruct the server to send the content in HTML format to the other network node.

4. The apparatus of claim 1, further comprising a logic circuit to reset the sensible indicator after content is redirected.

5. In a data network including a gateway server for interfacing data content obtained from a content server to a node comprising a mobile terminal, a method of redirecting at least some of the data content to another network node, comprising:
storing a user-supplied designation of the other network node;
storing an indication of whether the user has requested redirection of data content; and
routing data content to the mobile terminal or to the other network node according to the stored indication.

6. The method of claim 5 wherein the content from the server is in HTML format; and
the method further includes a step of converting HTML format to WAP format; and
the routing step is adapted to selectably route WAP-format content to the mobile terminal or to the other network node.

7. The method of claim 6, wherein the routing step is further adapted to instruct the server to send the content in HTML format to the other network node.

8. The apparatus of claim 5, further comprising a step of resetting the stored indication after content is redirected.
